(19) United States
(12) Patent Application Publication
(10) Pub. No.: US 2013/0141383 A1
(43) Pub. Date: Jun. 6, 2013

(54) Touch Sensing Using Motion Information

(71) Applicant: Adrian Woolley, Pleasanton, CA (US)

(72) Inventor: Adrian Woolley, Pleasanton, CA (US)

(21) Appl. No.: 13/310,088

(22) Filed: Dec. 2, 2011

(51) Int. Cl. G06F 3/044

(52) U.S. Cl. 345/174

(57) ABSTRACT

In one embodiment, a system includes a touch sensor, a motion module, and one or more computer-readable non-transitory storage media embodying logic. The logic is operable, when executed, to receive information from the touch sensor and receive information from the motion module. The logic is further operable to determine whether a touch input to the system has occurred based on the information from the motion module. The logic is further operable to determine coordinates associated with the touch input based on the information received from the touch sensor.

### BACKGROUND

A touch sensor may detect the presence and location of a touch or the proximity of an object (such as a user's finger or a stylus) within a touch-sensitive area of the touch sensor overlaid on a display screen or on a surface, as examples. In a touch sensitive display application, the touch position sensor may enable a user to interact directly with what is displayed on the screen, rather than indirectly with a mouse or touch pad. A touch sensor may be attached to or provided as part of a desktop computer, laptop computer, tablet computer, personal digital assistant (PDA), smartphone, satellite navigation device, portable media player, portable game console, kiosk computer, point-of-sale device, or other suitable device. A control panel on a household or other appliance may include a touch sensor.

There are a number of different types of touch position sensors, such as (for example) resistive touch screens, surface acoustic wave touch screens, capacitive touch screens, and optical touch screens (e.g., those using light emitting diodes and infrared sensors to detect touches). Herein, reference to a touch sensor may encompass a touch screen, and vice versa, where appropriate. When an object touches or comes within proximity of the surface of the capacitive touch screen, a change in capacitance may occur within the touch screen at the location of the touch or proximity. A touch-sensor controller may process the change in capacitance to determine its position on the touch screen.

Touch screens suffer from multiple issues. Accurately detecting touches as compared to noise needs improvement. Detecting what type of touches have occurred is also in need of improvement.

### BRIEF DESCRIPTION OF THE DRAWINGS

Reference is now made to the following description taken in conjunction with the accompanying drawings, wherein like reference numbers represent like parts and which:

FIG. 1 illustrates an example touch sensor with an example touch-sensor controller and an example motion module;

FIG. 2 illustrates an example method for detecting a touch in response to receiving motion information in a device with a touch screen;

FIG. 3 illustrates an example method for using motion information to determine whether a touch occurred on a device including a touch screen; and

FIG. 4 illustrates an example method for using motion information to quicken touch detection.

### DESCRIPTION OF EXAMPLE EMBODIMENTS

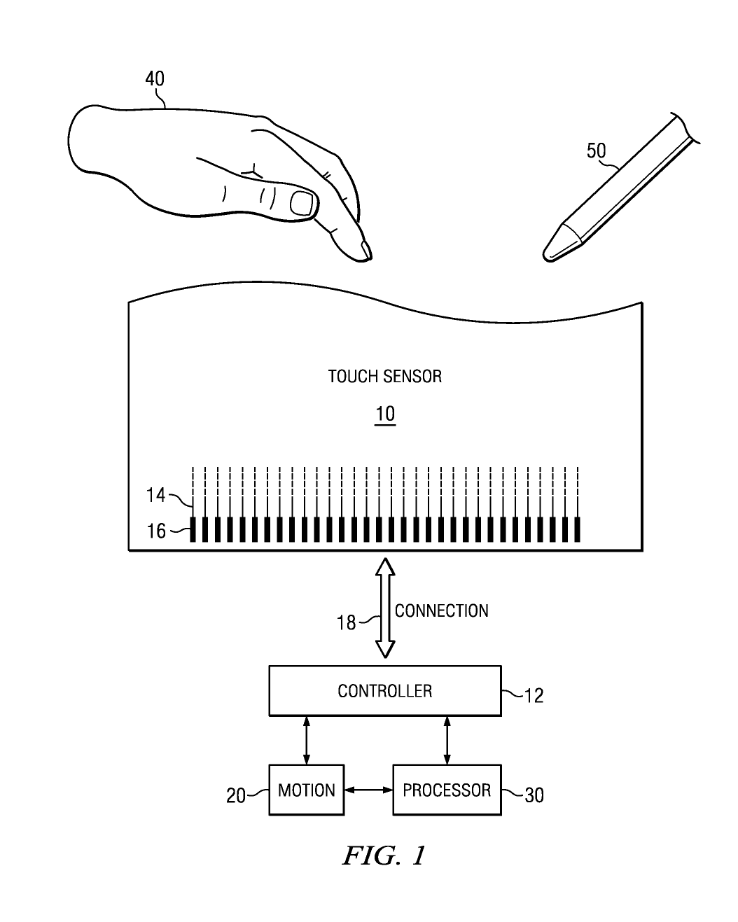

FIG. 1 illustrates an example touch sensor 10 with an example touch-sensor controller 12; touch-sensor controller 12 can communicate with an example motion module 20 and an example processor 30. Objects such as hand 40 and/or stylus 50 may contact and/or make gestures on touch sensor 10. Herein, reference to a touch sensor may encompass a touch screen or a touch-sensitive surface, and vice versa, where appropriate. Touch sensor 10 and touch-sensor controller 12 may detect the presence, location, and/or type of a touch or the proximity of an object (e.g., hand 40 and stylus 50) within a touch-sensitive area of touch sensor 10 using information from motion module 20. Herein, reference to a touch sensor may encompass both the touch sensor and its touch-sensor controller, where appropriate. Similarly, reference to a touch-sensor controller may encompass both the touch-sensor controller and its touch sensor, where appropriate. Touch sensor 10 may include one or more touch-sensitive areas, where appropriate. Touch sensor 10 may include an array of drive and sense electrodes (or an array of electrodes of a single type) disposed on one or more substrates, which may be made of a dielectric material. Herein, reference to a touch sensor may encompass both the electrodes of the touch sensor and the substrate(s) that they are disposed on, where appropriate. Alternatively, where appropriate, reference to a touch sensor may encompass the electrodes of the touch sensor, but not the substrate(s) that they are disposed on.

An electrode (whether a drive electrode or a sense electrode) may be an area of conductive material forming a shape, such as for example a disc, square, rectangle, other suitable shape, or suitable combination of these. One or more cuts in one or more layers of conductive material may (at least in part) create the shape of an electrode, and the area of the shape may (at least in part) be bounded by those cuts. In particular embodiments, the conductive material of an electrode may occupy approximately 100% of the area of its shape. As an example and not by way of limitation, an electrode may be made of indium tin oxide (ITO) and the ITO of the electrode may occupy approximately 100% of the area of its shape, where appropriate. In particular embodiments, the conductive material of an electrode may occupy approximately 5% of the area of its shape. As an example and not by way of limitation, an electrode may be made of fine lines of metal or other conductive material (such as for example copper, silver, or a copper- or silver-based material) and the fine lines of conductive material may occupy substantially less than 100% of the area of its shape in a hatched, mesh, or other suitable pattern. Although this disclosure describes or illustrates particular electrodes made of particular conductive material forming particular shapes with particular fills having particular patterns, this disclosure contemplates any suitable electrodes made of any suitable conductive material forming any suitable shapes with any suitable fills having any suitable patterns. Where appropriate, the shapes of the electrodes (or other elements) of a touch sensor may constitute in whole or in part one or more macro-features of the touch sensor. One or more characteristics of the implementation of those shapes (such as, for example, the conductive materials, fills, or patterns within the shapes) may constitute in whole or in part one or more micro-features of the touch sensor. One or more macro-features of a touch sensor may determine one or more characteristics of its functionality, and one or more micro-features of the touch sensor may determine one or more optical features of the touch sensor, such as transmittance, refraction, or reflection.

One or more portions of the substrate of touch sensor 10 may be made of polyethylene terephthalate (PET) or another suitable material. This disclosure contemplates any suitable substrate with any suitable portions made of any suitable material. In particular embodiments, the drive or sense electrodes in touch sensor 10 may be made of ITO in whole or in part. In particular embodiments, the drive or sense electrodes in touch sensor 10 may be made of fine lines of metal or other conductive material. As an example and not by way of limitation, one or more portions of the conductive material may be copper or copper-based and have a thickness of approximately 5 μm or less and a width of approximately 10 μm or less. As another example, one or more portions of the conductive material may be silver or silver-based and similarly have a thickness of approximately 5 μm or less and a width of approximately 10 μm or less. This disclosure contemplates any suitable electrodes made of any suitable material.

A mechanical stack may contain the substrate (or multiple substrates) and the conductive material forming the drive or sense electrodes of touch sensor 10. As an example and not by way of limitation, the mechanical stack may include a first layer of optically clear adhesive (OCA) beneath a cover panel. The cover panel may be clear and made of a resilient material suitable for repeated touching, such as for example glass, polycarbonate, or poly(methyl methacrylate) (PMMA). This disclosure contemplates any suitable cover panel made of any suitable material. The first layer of OCA may be disposed between the cover panel and the substrate with the conductive material forming the drive or sense electrodes. The mechanical stack may also include a second layer of OCA and a dielectric layer (which may be made of PET or another suitable material, similar to the substrate with the conductive material forming the drive or sense electrodes). As an alternative, where appropriate, a thin coating of a dielectric material may be applied instead of the second layer of OCA and the dielectric layer. The second layer of OCA may be disposed between the substrate with the conductive material making up the drive or sense electrodes and the dielectric layer, and the dielectric layer may be disposed between the second layer of OCA and an air gap to a display of a device including touch sensor 10 and touch-sensor controller 12. As an example only and not by way of limitation, the cover panel may have a thickness of approximately 1 mm; the first layer of OCA may have a thickness of approximately 0.05 mm; the substrate with the conductive material forming the drive or sense electrodes may have a thickness of approximately 0.05 mm; the second layer of OCA may have a thickness of approximately 0.05 mm; and the dielectric layer may have a thickness of approximately 0.05 mm. Although this disclosure describes a particular mechanical stack with a particular number of particular layers made of particular materials and having particular thicknesses, this disclosure contemplates any suitable mechanical stack with any suitable number of any suitable layers made of any suitable materials and having any suitable thicknesses. As an example and not by way of limitation, in particular embodiments, a layer of adhesive or dielectric may replace the dielectric layer, second layer of OCA, and air gap described above, with there being no air gap to the display.

Touch sensor 10 may implement a capacitive form of touch sensing. As examples, touch sensor 10 may implement mutual-capacitance sensing, self-capacitance sensing, or a combination of mutual and self capacitive sensing. In a mutual-capacitance implementation, touch sensor 10 may include an array of drive and sense electrodes forming an array of capacitive nodes. A drive electrode and a sense electrode may form a capacitive node. The drive and sense electrodes forming the capacitive node may come near each other, but not make electrical contact with each other. Instead, the drive and sense electrodes may be capacitively coupled to each other across a space between them. A pulsed or alternating voltage applied to the drive electrode (by touch-sensor controller 12) may induce a charge on the sense electrode, and the amount of charge induced may be susceptible to external influence (such as a touch or the proximity of an object). When an object touches or comes within proximity of the capacitive node, a change in capacitance may occur at the capacitive node and touch-sensor controller 12 may measure the change in capacitance. By measuring changes in capacitance throughout the array, touch-sensor controller 12 may determine the position of the touch or proximity within the touch-sensitive area(s) of touch sensor 10.

In a self-capacitance implementation, touch sensor 10 may include an array of electrodes of a single type that may each form a capacitive node. When an object touches or comes within proximity of the capacitive node, a change in self-capacitance may occur at the capacitive node and touch-sensor controller 12 may measure the change in capacitance, for example, as a change in the amount of charge needed to raise the voltage at the capacitive node by a pre-determined amount. As with a mutual-capacitance implementation, by measuring changes in capacitance throughout the array, touch-sensor controller 12 may determine the position of the touch or proximity within the touch-sensitive area(s) of touch sensor 10. This disclosure contemplates any suitable form of capacitive touch sensing, where appropriate.

In particular embodiments, one or more drive electrodes may together form a drive line running horizontally or vertically or in any suitable orientation. Similarly, one or more sense electrodes may together form a sense line running horizontally or vertically or in any suitable orientation. In particular embodiments, drive lines may run substantially perpendicular to sense lines. Herein, reference to a drive line may encompass one or more drive electrodes making up the drive line, and vice versa, where appropriate. Similarly, reference to a sense line may encompass one or more sense electrodes making up the sense line, and vice versa, where appropriate.

Touch sensor 10 may have drive and sense electrodes disposed in a pattern on one side of a single substrate. In such a configuration, a pair of drive and sense electrodes capacitively coupled to each other across a space between them may form a capacitive node. For a self-capacitance implementation, electrodes of only a single type may be disposed in a pattern on a single substrate. In addition or as an alternative to having drive and sense electrodes disposed in a pattern on one side of a single substrate, touch sensor 10 may have drive electrodes disposed in a pattern on one side of a substrate and sense electrodes disposed in a pattern on another side of the substrate. Moreover, touch sensor 10 may have drive electrodes disposed in a pattern on one side of one substrate and sense electrodes disposed in a pattern on one side of another substrate. In such configurations, an intersection of a drive electrode and a sense electrode may form a capacitive node. Such an intersection may be a location where the drive electrode and the sense electrode “cross” or come nearest each other in their respective planes. The drive and sense electrodes do not make electrical contact with each other—instead they are capacitively coupled to each other across a dielectric at the intersection. Although this disclosure describes particular configurations of particular electrodes forming particular nodes, this disclosure contemplates any suitable configuration of any suitable electrodes forming any suitable nodes. Moreover, this disclosure contemplates any suitable electrodes disposed on any suitable number of any suitable substrates in any suitable patterns.

As described above, a change in capacitance at a capacitive node of touch sensor 10 may indicate a touch or proximity input at the position of the capacitive node. Touch-sensor controller 12 may detect and process the change in capacitance to determine the presence and location of the touch or proximity input. Touch-sensor controller 12 may then communicate information about the touch or proximity input to one or more other components (such one or more central processing units (CPUs) or digital signal processors (DSPs)) of a device that includes touch sensor 10 and touch-sensor controller 12, which may respond to the touch or proximity input by initiating a function of the device (or an application running on the device) associated with it. Although this disclosure describes a particular touch-sensor controller having particular functionality with respect to a particular device and a particular touch sensor, this disclosure contemplates any suitable touch-sensor controller having any suitable functionality with respect to any suitable device and any suitable touch sensor.

Touch-sensor controller 12 may be one or more integrated circuits (ICs)—such as for example general-purpose microprocessors, microcontrollers, programmable logic devices or arrays, application-specific ICs (ASICs). In particular embodiments, touch-sensor controller 12 comprises analog circuitry, digital logic, and digital non-volatile memory. In particular embodiments, touch-sensor controller 12 is disposed on a flexible printed circuit (FPC) bonded to the substrate of touch sensor 10, as described below. The FPC may be active or passive. In particular embodiments, multiple touch-sensor controllers 12 are disposed on the FPC. Touch-sensor controller 12 may include a processor unit, a drive unit, a sense unit, and a storage unit. The drive unit may supply drive signals to the drive electrodes of touch sensor 10. The sense unit may sense charge at the capacitive nodes of touch sensor 10 and provide measurement signals to the processor unit representing capacitances at the capacitive nodes. The processor unit may control the supply of drive signals to the drive electrodes by the drive unit and process measurement signals from the sense unit to detect and process the presence and location of a touch or proximity input within the touch-sensitive area(s) of touch sensor 10. The processor unit may also track changes in the position of a touch or proximity input within the touch-sensitive area(s) of touch sensor 10. The storage unit may store programming for execution by the processor unit, including programming for controlling the drive unit to supply drive signals to the drive electrodes, programming for processing measurement signals from the sense unit, and other suitable programming, where appropriate. Although this disclosure describes a particular touch-sensor controller having a particular implementation with particular components, this disclosure contemplates any suitable touch-sensor controller having any suitable implementation with any suitable components.

Tracks 14 of conductive material disposed on the substrate of touch sensor 10 may couple the drive or sense electrodes of touch sensor 10 to bond pads 16, also disposed on the substrate of touch sensor 10. As described below, bond pads 16 facilitate coupling of tracks 14 to touch-sensor controller 12. Tracks 14 may extend into or around (e.g. at the edges of) the touch-sensitive area(s) of touch sensor 10. Particular tracks 14 may provide drive connections for coupling touch-sensor controller 12 to drive electrodes of touch sensor 10, through which the drive unit of touch-sensor controller 12 may supply drive signals to the drive electrodes. Other tracks 14 may provide sense connections for coupling touch-sensor controller 12 to sense electrodes of touch sensor 10, through which the sense unit of touch-sensor controller 12 may sense charge at the capacitive nodes of touch sensor 10. Tracks 14 may be made of fine lines of metal or other conductive material. As an example and not by way of limitation, the conductive material of tracks 14 may be copper or copper-based and have a width of approximately 100 μm or less. As another example, the conductive material of tracks 14 may be silver or silver-based and have a width of approximately 100 μm or less. In particular embodiments, tracks 14 may be made of ITO in whole or in part in addition or as an alternative to fine lines of metal or other conductive material. Although this disclosure describes particular tracks made of particular materials with particular widths, this disclosure contemplates any suitable tracks made of any suitable materials with any suitable widths. In addition to tracks 14, touch sensor 10 may include one or more ground lines terminating at a ground connector (which may be a bond pad 16) at an edge of the substrate of touch sensor 10 (similar to tracks 14).

Bond pads 16 may be located along one or more edges of the substrate, outside the touch-sensitive area(s) of touch sensor 10. As described above, touch-sensor controller 12 may be on an FPC. Bond pads 16 may be made of the same material as tracks 14 and may be bonded to the FPC using an anisotropic conductive film (ACF). Connection 18 may include conductive lines on the FPC coupling touch-sensor controller 12 to bond pads 16, in turn coupling touch-sensor controller 12 to tracks 14 and to the drive or sense electrodes of touch sensor 10. This disclosure contemplates any suitable connection 18 between touch-sensor controller 12 and touch sensor 10.

In some embodiments, motion module 10 may include one or more sensors that provide information regarding motion. For example, motion module 10 may be or include one or more of: a uni- or multi-dimensional accelerometer, a gyroscope, and a magnetometer. As examples, BOSCH BMA220 module or the KIONIX KTXF9 module may be used to implement module 10. Motion module 10 may be configured to communicate information to and/or from touch-sensor controller 12 and/or processor 30. In some embodiments, touch-sensor controller 12 may serve as a go-between for information communicated between motion module 20 and processor 30.

In some embodiments, processor 30 may be included in a device that also includes touch sensor 10 and touch-sensor controller 12. Processor 30 may be implemented using one or more central processing units, such as those implemented using the ARM architecture or the X86 architecture. Processor 30 may have one or more cores, including one or more graphic cores. As examples, processor 30 may be implemented using NVIDIA TEGRA, QUALCOMM SNAPDRAGON, or TEXAS INSTRUMENTS OMAP processors. In some embodiments, processor 30 may receive information from touch-sensor controller 12 and motion module 10 and process that information as specified by applications executed by processor 30.

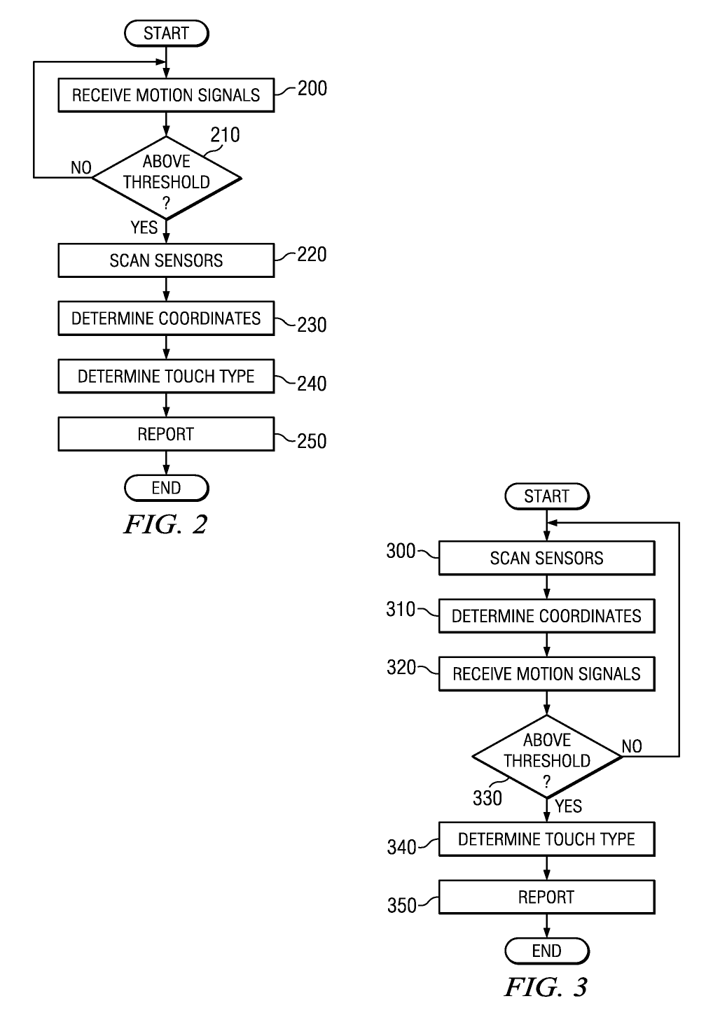

In some embodiments, touch-sensor controller 12 may use information from touch sensor 10 and motion module 20 to detect the presence, location, and/or type of a touch or the proximity of an object (e.g., hand 40 and stylus 50). As further described below with respect to FIGS. 2-4, information from motion module 20 may be used by touch-sensor controller 12 to provide one or more advantages, such as detecting: whether a touch occurred (e.g., distinguishing actual touches from noise events like a droplet of water being present on a device or electrical noise events such as electrical noise emitted from other components such as battery charging components or devices), what type of touch occurred (e.g., a hard touch or a soft touch), and what type of object made the touch (e.g., stylus 50 or hand 40).

FIGS. 2-4 illustrate example methods for using motion information to enhance touch detection. Some embodiments may repeat the steps of the methods of FIGS. 2-4, where appropriate. Moreover, although this disclosure describes and illustrates particular steps of the methods of FIGS. 2-4 as occurring in a particular order, this disclosure contemplates any suitable steps of the methods of FIGS. 2-4 occurring in any suitable order. Furthermore, although this disclosure describes and illustrates particular components, devices, or systems carrying out particular steps of the methods of FIGS. 2-4, this disclosure contemplates any suitable combination of any suitable components, devices, or systems carrying out any suitable steps of any of the methods of FIGS. 2-4.

FIG. 2 illustrates an example method for detecting a touch in response to receiving motion information in a device with a touch screen such as the device depicted in FIG. 1. The method may start at step 200, where motion signals are received by a touch-sensor controller. For example, motion signals may be sent by an accelerometer. The motion signals may include information regarding motion in one or more dimensions. For example, the motion information may include acceleration measurements in the X, Y and Z axes. Motion module 20 is an example of a device that may provide the motion signals received at step 200.

At step 210, in some embodiments, the motion signals received at step 200 may be compared to one or more thresholds. This step may be performed by the touch-sensor controller that received the motion signals at step 200. Touch-sensor controller 12 of FIG. 1 is an example implementation of a touch-sensor controller that may be used to compare the motion signals to one or more thresholds at this step. The one or more thresholds used at this step may be determined, in some embodiments, by determining values that indicate contact with a touch screen. One example of a threshold that may be used at this step is 250 mG. The value(s) used as threshold(s) may be affected by, for example, the size of the device, the placement of the motion module that provides the motion signals in the device, and/or the characteristics of the frame and touch surface of the device. In some embodiments, only one component of the motion information may be compared to one or more thresholds at this step. For example, the Z-axis component of the signals received at step 200 may be compared to one or more thresholds at this step. This may be advantageous because the Z-axis component of the motion information may be the axis most affected by a touch on a device. Other suitable axes may be chosen depending on the configuration of the device, how the device may be used, and/or the motion module used in the device. In some embodiments, all of the components of the motion information received at step 200 may be compared to one or more thresholds at this step. For example, the vector magnitude of the motion signals may be calculated by combining the axes measurements as a dot product and then determining the peak values to be used in the comparison. As another example, the values associated with the various components of the motion information received at step 200 may be combined (e.g., averaged or normalized) and this may be compared to one or more thresholds at this step.

If the motion signals received at step 200 are greater than the one or more thresholds then step 220 may be performed. If they are not greater than the one or more thresholds, then step 200 may be performed. In this manner, in some embodiments, the motion information received at step 200 may serve as a trigger for scanning a touch screen or a touch-sensitive surface. For example, a scan of the touch sensors may not be performed until motion signals received at step 200 are greater than the threshold(s) used at step 210.

At step 220, in some embodiments, the touch screen or touch-sensitive surface of the device may be scanned. As discussed above with respect to touch sensor 10 and touch-sensor controller 12 of FIG. 1, signals may be sent to the touch sensor by the touch-sensor controller and other signals may be received by the touch-sensor controller from the touch sensor to detect a where a touch may have occurred. For example, drive lines of a touch sensor may be sequentially driven and the signals present on sense lines may be detected while each of the drive lines are being driven.

At step 230, in some embodiments, coordinates corresponding to one or more touches may be determined. This may be done using the information received at step 220. A touch-sensor controller such as touch-sensor controller 12 of FIG. 1 may be used to perform this step. Coordinates of a touch may be determined by correlating signals received on sense lines with the time such signals were received and when the drive lines were driven. For example, when a drive line is driven, the touch-sensor controller may receive signals indicating a touch on a sense line. Because the touch-sensor controller knows when the drive line was driven, the touch-sensor controller may determine the coordinates of the touch sensed on the sense line by examining the time when signals were received from the sense line.

At step 240, in some embodiments, the type of touch or touches may be determined. This may be determined using the motion information received at step 200. For example, it may be determined at this step whether the touch or touches were light or soft as opposed to heavy or hard. As another example, the touch type determined at this step may include determining what type of object touched the device, such as whether the object was a hand or a stylus. Determinations made at this step may also use the information received at steps 200, 220, and 230. For example, the magnitude of one or more components of the signals received at step 200 may be compared to the coordinates determined at step 230. By comparing this information, the touch types may be determined. For example, the magnitude of the component of the signals received at step 200 that corresponds to the Z-axis may be used to determine whether the touch was a soft or a hard touch. The following are example ranges that may be used to determine the types of touches:

| | Soft Finger | Hard Finger Tap | Stylus Tap |
|---|---|---|---|
| | Tap (mG) | (mG) | (mG) |
| Example 1 | 250-1900 | 1901-6900 | at least 6901 |
| Example 2 | 250-1250 | 1251-5375 | at least 5376 |
| Example 3 | 250-1380 | 1381-5010 | at least 5011 |
| Example 4 | 250-2220 | 2221-4750 | at least 4751 |
| Example 5 | 250-1410 | 1411-4980 | at least 4981 |
| Example 6 | 250-2850 | 2851-7275 | at least 7276 |

As another example, the area indicated by the coordinates of the touch may also be compared to the motion signals received at step 200 to determine whether the touch was from an object such as a finger or an object such as a stylus. For example, if the area indicated by the coordinates determined at step 230 is relatively small and the motions signals received at step 200 indicate are high in value then it may be determined that a touch is similar to a touch performed by a stylus. As another example, if the coordinates determined at step 230 are indicating a relatively large area and the motion signals that received at step 200 are relatively small in magnitude, then it may be determined that the touch was likely performed by a human hand such as a finger.

In some embodiments, a duration associated with the motion information received at step 200 touch may be used to determine what type of touch occurred. For example, if the motion information received at step 200 has a relatively short duration, then a stylus type touch maybe determined whereas if the motion information has a relatively long duration, then a soft touch or a hard finger performed by a human finger may be determined.

In some embodiments, the frequency characteristics of the motion information received at step 200 may be used to determine the type of touch. For example, analyzing the motion information in the frequency domain may allow for the detection of characteristic frequencies of different types of touches (e.g., a hard touch, a soft touch, a stylus touch). Detecting the characteristic frequencies may allow for determining the touch type.

At step 250, in some embodiments, the touch-sensor controller may report to a processor or other component of the device one or more of the results of the steps above, at which point the method may end. For example, the coordinates corresponding to the touch(es) detected as well as the touch type(s) detected may be reported at this step. The processor or component that receives the report at this step may be similar to or substantially the same as processor 30 of FIG. 1. In some embodiments, this may provide one or more advantages. For example, the processor may be able to execute programs that operate in different manners depending on the type of touch that is detected. As an example, if a soft touch is detected, one action may be executed by the program whereas a detected hard touch would cause a different action to occur. As another example, a program may be performed to operate differently if a stylus touches the device as opposed to a human finger. Applications such as drawing programs, games or other suitable applications may benefit from being able to distinguish between different touch types.

FIG. 3 illustrates an example method for using motion information to determine whether a touch occurred on a device including a touch screen or a touch-sensitive surface such as the device illustrated in FIG. 1. The method may start at step 300, where the touch screen or touch-sensitive surface of the device may be scanned. As discussed above with respect to touch sensor 10 and touch-sensor controller 12 of FIG. 1, signals may be sent to the touch sensor by the touch-sensor controller and other signals may be received by the touch-sensor controller from the touch sensor to detect a where a touch may have occurred. For example, drive lines of a touch sensor may be sequentially driven and the signals present on sense lines may be detected while each of the drive lines are being driven.

At step 310, in some embodiments, coordinates corresponding to one or more touches may be determined. This may be done using the information received at step 300. A touch-sensor controller, such as touch-sensor controller 12 of FIG. 1, may be used to perform this step. Coordinates of a touch may be determined by correlating signals received on sense lines with the time such signals were received and when the drive lines were driven. For example, when a drive line is driven, the touch-sensor controller may receive signals indicating a touch on a sense line. Because the touch-sensor controller knows when the drive line was driven, the touch-sensor controller may determine the coordinates of the touch sensed on the sense line by examining the time when signals were received from the sense line.

At step 320, in some embodiments, motion signals are received by a touch-sensor controller. For example, motion signals may be sent by an accelerometer. The motion signals may include information regarding motion in one or more dimensions. For example, the motion information may include acceleration measurements in the X, Y and Z axes. Motion module 20 of FIG. 1 is an example of a device that may provide the motion signals received at step 320.

At step 330, in some embodiments, the motion signals received at step 320 may be compared to one or more thresholds. This step may be performed by the touch-sensor controller. Touch-sensor controller 12 of FIG. 1 is an example implementation of a touch-sensor controller that may be used to compare the motion signals to one or more thresholds at this step. The one or more thresholds used at this step may be determined, in some embodiments, by determining values that indicate contact with a touch screen or touch-sensitive surface. One example of a threshold that may be used at this step is 250 mG. The value(s) used as threshold(s) may be affected by, for example, the size of the device, the placement of the motion module that provides the motion signals in the device, and/or the characteristics of the frame and touch screen or touch-sensitive surface of the device. In some embodiments, only one component of the motion information may be compared to one or more thresholds at this step. For example, the Z-axis component of the signals received at step 320 may be compared to one or more thresholds at this step. This may be advantageous because the Z-axis component of the motion information may be the axis most affected by a touch on a device. Other suitable axes may be chosen depending on the configuration of the device, how the device may be used, and/or the motion module used in the device. In some embodiments, all of the components of the motion information received at step 320 may be compared to one or more thresholds at this step. For example, the vector magnitude of the motion signals may be calculated by combining the axes measurements as a dot product and then determining the peak values to be used in the comparison. As another example, the values associated with the various components of the motion information received at step 200 may be combined (e.g., averaged or normalized) and this may be compared to one or more thresholds at this step.

If the motion signals received at step 320 are greater than the one or more thresholds then step 340 may be performed. If they are not greater than the one or more thresholds, then step 300 may be performed. In this manner, in some embodiments, the motion information received at step 320 may serve as a verification that a touch occurred on the device. For example, reporting the coordinates determined at step 310 may not be performed until motion signals received at step 320 are greater than the threshold(s) used at step 330.

At step 340, in some embodiments, the type(s) of touch(es) may be determined. This may be determined using the motion information received at step 320. For example, it may be determined at this step whether the touch or touches were light or soft as opposed to heavy or hard. As another example, the touch type determined at this step may include determining what type of object touched the device, such as whether the object was a hand or a stylus. Determinations made at this step may also use the information received at steps 300, 310, and 320. For example, the magnitude of one or more components of the signals received at step 320 may be compared to the coordinates determined at step 310. By comparing this information, the touch types may be determined. For example, the magnitude of the component of the signals received at step 320 that corresponds to the Z-axis may be used to determine whether the touch was a soft or a hard touch. The following are example ranges that may be used to determine the types of touches:

| | Soft Finger | Hard Finger Tap | Stylus Tap |
|---|---|---|---|
| | Tap (mG) | (mG) | (mG) |
| Example 1 | 250-1900 | 1901-6900 | at least 6901 |
| Example 2 | 250-1250 | 1251-5375 | at least 5376 |
| Example 3 | 250-1380 | 1381-5010 | at least 5011 |
| Example 4 | 250-2220 | 2221-4750 | at least 4751 |
| Example 5 | 250-1410 | 1411-4980 | at least 4981 |
| Example 6 | 250-2850 | 2851-7275 | at least 7276 |

As another example, the area indicated by the coordinates of the touch may also be compared to the motion signals received at step 320 to determine whether the touch was from an object such as a finger or an object such as a stylus. For example, if the area indicated by the coordinates determined at step 310 is relatively small and the motions signals received at step 320 indicate are high in value then it may be determined that a touch is similar to a touch performed by a stylus. As another example, if the coordinates determined at step 310 are indicating a relatively large area and the motion signals that received at step 320 are relatively small in magnitude, then it may be determined that the touch was likely performed by a human hand such as a finger.

In some embodiments, a duration associated with the motion information received at step 320 touch may be used to determine what type of touch occurred. For example, if the motion information received at step 320 has a relatively short duration, then a stylus type touch maybe determined whereas if the motion information has a relatively long duration, then a soft touch or a hard finger performed by a human finger may be determined.

In some embodiments, the frequency characteristics of the motion information received at step 320 may be used to determine the type of touch. For example, analyzing the motion information in the frequency domain may allow for the detection of characteristic frequencies of different types of touches (e.g., a hard touch, a soft touch, a stylus touch). Detecting the characteristic frequencies may allow for determining the touch type.

At step 350, in some embodiments, the touch-sensor controller may report to a processor or other component of the device one or more of the results of the steps above, at which point the method may end. For example, the coordinates corresponding to the touch(es) detected as well as the touch type(s) detected may be reported at this step. The processor or component that receives the report at this step may be similar to or substantially the same as processor 30 of FIG. 1. In some embodiments, this may provide one or more advantages. For example, the processor may be able to execute programs that operate in different manners depending on the type of touch that is detected. As an example, if a soft touch is detected, one action may be executed by the program whereas a detected hard touch would cause a different action to occur. As another example, a program may be performed to operate differently if a stylus touches the device as opposed to a human finger. Applications such as drawing programs, games or other suitable applications may benefit from being able to distinguish between different touch types.

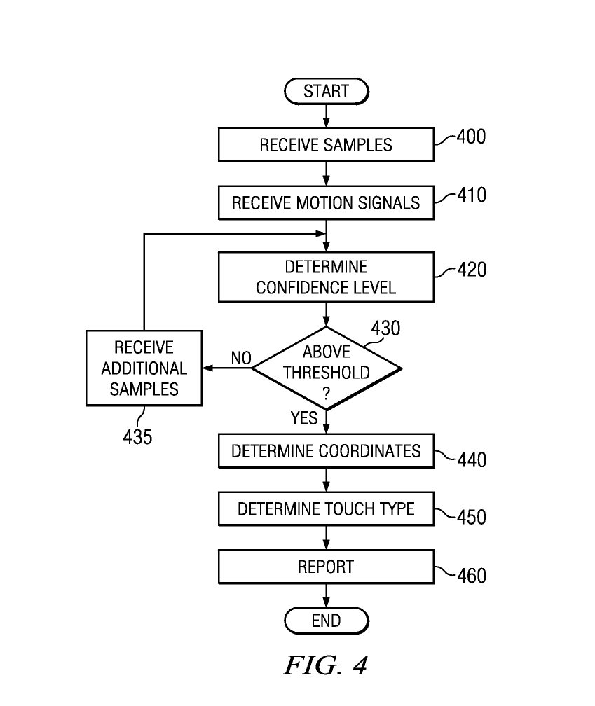

FIG. 4 illustrates an example method for using motion information to quicken touch detection. The method may start at step 400, where samples from a touch screen or touch-sensitive surface may be received. For example, as described above in FIG. 1, a touch screen may be configured to have multiple drive lines and multiple sense lines. The drive lines may be driven sequentially and the sense lines may be analyzed to determine whether signals indicating a touch are present on the sense lines. A touch sensor such as touch sensor 10 of FIG. 1 may provide such samples and a touch-sensor controller such as touch-sensor controller 12 of FIG. 1 may receive the samples at this step.

At step 410, in some embodiments, motion signals are received by a touch-sensor controller. For example, motion signals may be sent by an accelerometer. The motion signals may include information regarding motion in one or more dimensions. For example, the motion information may include acceleration measurements in the X, Y and Z axes. Motion module 20 of FIG. 1 is an example of a device that may provide the motion signals received at this step.

At step 420, in some embodiments, a confidence level may be determined. This confidence level may indicate or reflect a probability that a touch occurred. The confidence level may be determined based on the samples received at step 400 and the motion signals received at step 410. A confidence level may be preset at an initial value and information such as the samples received at step 400 and the motion signals received at step 410 may be used to modify the confidence level. For example, if the motion signals received at step 410 indicate small or weak values, then the confidence level may not be increased or may be increased by a relatively small amount. As another example, if the samples received at step 400 are small or weak in magnitude, then the confidence level may not be increased or may be increased by a relatively small amount. As another example, if the signals received at step 410 are relatively large in magnitude, then the confidence level may be substantially increased. As another example, if the samples received at step 400 are large in magnitude then the confidence level may be substantially increased.

At step 430, some embodiments, it may be determined whether the confidence level is above one or more thresholds. If the confidence level is above the threshold(s), then step 440 may be performed. If the confidence level is not above the threshold(s), then step 435 may be performed. This determination, for example, may indicate whether detected activity (indicated by the information received at steps 400 and 410) are likely to be indicative of a touch. In some embodiments, using the confidence level touches may be differentiated from noise (e.g., electromagnetic noise or items such as water droplets being present on the device). Using the received motion signals at step 410 in the determination of the confidence level at step 420 may be advantageous, in some embodiments, because it may indicate an increased probability that a touch occurred. Increasing the confidence level using the received motion signals may reduce the number of samples that need to be received before the threshold is exceeded at step 430. This may provide for faster response times, as an example, because it may reduce the number of scans that need to be performed on the touch screen or touch-sensitive surface.

At step 435, in some embodiments, additional samples may be received. These samples may be samples of data from the touch sensor. This may be performed in a fashion similar to step 400. Receiving additional samples at step 435 may be a result of not exceeding the threshold at step 430 which may indicate an insufficient probability that a touch has occurred.

At step 440, in some embodiments, coordinates corresponding to one or more touches may be determined. This may be done using the information received at steps 400 and/or 435. A touch-sensor controller, such as touch-sensor controller 12 of FIG. 1, may be used to perform this step. Coordinates of a touch may be determined by correlating signals received on sense lines with the time such signals were received and when the drive lines were driven. For example, when a drive line is driven, the touch-sensor controller may receive signals indicating a touch on a sense line. Because the touch-sensor controller knows when the drive line was driven, the touch-sensor controller may determine the coordinates of the touch sensed on the sense line by examining the time when signals were received from the sense line.

At step 450, in some embodiments, one or more touch types may be determined. This step may be performed using one or more of the techniques discussed above with respect to step 340 of FIG. 3. Information used at this step may include the information from steps 400, 410, and/or 435. One or more advantages discussed at step 340 of FIG. 3 may also be present at step 450 in various embodiments.

At step 460, the touch-sensor controller may report to a processor or other component of the device one or more of the results of the steps above, at which point the method may end. For example, the coordinates corresponding to the touch(es) detected as well as the touch type(s) detected may be reported at this step. The processor or component that receives the report at this step may be similar to or substantially the same as processor 30 of FIG. 1. In some embodiments, this may provide one or more advantages. For example, the processor may be able to execute programs that operate in different manners depending on the type of touch that is detected. As an example, if a soft touch is detected, one action may be executed by the program whereas a detected hard touch would cause a different action to occur. As another example, a program may be performed to operate differently if a stylus touches the device as opposed to a human finger. Applications such as drawing programs, games or other suitable applications may benefit from being able to distinguish between different touch types.

Depending on the specific features implemented, particular embodiments may exhibit some, none, or all of the following technical advantages. Manufacturing of touch sensitive systems (e.g., touch screens or touch-sensitive surfaces) may be performed faster. Manufacturing of touch sensitive systems (e.g., touch screens or touch-sensitive surfaces) may be performed at a lower cost than conventional techniques. Increased yield may be realized during manufacturing. Tooling for manufacturing may become more simplified. Moisture ingress in touch sensitive systems (e.g., touch screens or touch-sensitive surfaces) may be reduced or eliminated. The reliability of an interface between a touch sensor and processing components may be enhanced. Other technical advantages will be readily apparent to one skilled in the art from the preceding figures and description as well as the proceeding claims. Particular embodiments may provide or include all the advantages disclosed, particular embodiments may provide or include only some of the advantages disclosed, and particular embodiments may provide none of the advantages disclosed.

Herein, reference to a computer-readable storage medium encompasses one or more non-transitory, tangible computer-readable storage media possessing structure. As an example and not by way of limitation, a computer-readable storage medium may include a semiconductor-based or other integrated circuit (IC) (such, as for example, a field-programmable gate array (FPGA) or an application-specific IC (ASIC)), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. Herein, reference to a computer-readable storage medium excludes any medium that is not eligible for patent protection under 35 U.S.C. §101. Herein, reference to a computer-readable storage medium excludes transitory forms of signal transmission (such as a propagating electrical or electromagnetic signal per se) to the extent that they are not eligible for patent protection under 35 U.S.C. §101. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

This disclosure encompasses all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. A system comprising:
a touch sensor;
a motion module; and
one or more computer-readable non-transitory storage media embodying logic that is operable when executed to:
receive information from the touch sensor;
receive information from the motion module;
determine whether a touch input to the system has occurred based on the information from the motion module; and
determine coordinates associated with the touch input based on the information received from the touch sensor.

2. The system of claim 1, wherein the motion module comprises an accelerometer.

3. The system of claim 1, wherein the logic is operable to determine that the touch input occurred based on the information from the motion module by determining that the information from the motion module is greater than a threshold.

4. The system of claim 3, wherein the logic is operable to receive the information from the touch sensor by causing a scan of the touch sensor in response to determining that the information from the motion module is greater than the threshold.

5. The system of claim 1, wherein the logic is operable to determine that the touch input occurred based on the information from the motion module by:
determining a first confidence level based on the information from the touch sensor and the information from the motion module;
determining that the first confidence level is below a threshold;
in response to determining that the first confidence level is below the threshold, receiving a second set of information from the touch sensor;
determining a second confidence level based on the second set of information from the touch sensor; and
determining that the second confidence level is greater than the threshold.

6. The system of claim 1, wherein:
the touch sensor comprises a second set of electrodes;
the first set of electrodes are arranged along a first axis; and
the second set of electrodes are arranged along a second axis, the first and second axes being substantially perpendicular to each other.

7. The system of claim 1, wherein one or more portions of the first set of electrodes comprises indium tin oxide (ITO).

8. A method, performed by executing logic embodied by one or more computer-readable non-transitory storage media, comprising:
receiving information from a touch sensor;
receiving information from a motion module;
determining whether a touch input to a device comprising the touch sensor and comprising the motion module has occurred based on the information from the motion module; and
determining coordinates associated with the touch input based on the information received from the touch sensor.

9. The method of claim 8, wherein the motion module comprises an accelerometer.

10. The method of claim 8, wherein determining that the touch input occurred based on the information from the motion module comprises determining that the information from the motion module is greater than a threshold.

11. The method of claim 10, wherein receiving the information from the touch sensor comprises causing a scan of the touch sensor in response to determining that the information from the motion module is greater than the threshold.

12. The method of claim 8, wherein determining that the touch input occurred based on the information from the motion module comprises:
determining a first confidence level based on the information from the touch sensor and the information from the motion module;
determining that the first confidence level is below a threshold;
in response to determining that the first confidence level is below the threshold, receiving a second set of information from the touch sensor;
determining a second confidence level based on the second set of information from the touch sensor; and
determining that the second confidence level is greater than the threshold.

13. The method of claim 8, wherein:
the information from the motion module comprises:
information corresponding to a first axis;
information corresponding to a second axis; and
information corresponding to a third axis; and
determining whether the touch input has occurred based on the information from the motion module comprises comparing the information corresponding to the first axis to a threshold.

14. The method of claim 8, wherein:
the information from the motion module comprises:
information corresponding to a first axis;
information corresponding to a second axis; and
information corresponding to a third axis; and
determining whether the touch input has occurred based on the information from the motion module comprises:
determining a magnitude based on the information corresponding to the first axis, the information corresponding to the second axis, and the information corresponding to the third axis; and
comparing the magnitude to a threshold.

15. One or more computer-readable non-transitory storage media embodying logic that is operable when executed to:
receive information from a touch sensor;
receive information from a motion module;
determine whether a touch input to a device comprising the touch sensor and comprising the motion module has occurred based on the information from the motion module; and
determine coordinates associated with the touch input based on the information received from the touch sensor.

16. The media of claim 15, wherein the logic operable to receive information from the motion module comprises logic operable to receive information from an accelerometer.

17. The media of claim 15, wherein the logic is operable to determine that the touch input occurred based on the information from the motion module by determining that the information from the motion module is greater than a threshold.

18. The media of claim 17, wherein the logic is operable to receive the information from the touch sensor by causing a scan of the touch sensor in response to determining that the information from the motion module is greater than the threshold.

19. The media of claim 15, wherein the logic is operable to determine that the touch input occurred based on the information from the motion module by:
determining a first confidence level based on the information from the touch sensor and the information from the motion module;
determining that the first confidence level is below a threshold;
in response to determining that the first confidence level is below the threshold, receiving a second set of information from the touch sensor;
determining a second confidence level based on the second set of information from the touch sensor; and
determining that the second confidence level is greater than the threshold.

20. The media of claim 15, wherein:
the information from the motion module comprises:
information corresponding to a first axis;
information corresponding to a second axis; and
information corresponding to a third axis; and
the logic is operable to determine whether the touch input has occurred based on the information from the motion module by comparing the information corresponding to the first axis to a threshold.

21. The media of claim 15, wherein:
the information from the motion module comprises:
information corresponding to a first axis;
information corresponding to a second axis; and
information corresponding to a third axis; and
the logic is operable to determine whether the touch input has occurred based on the information from the motion module by:
determining a magnitude based on the information corresponding to the first axis, the information corresponding to the second axis, and the information corresponding to the third axis; and
comparing the magnitude to a threshold.
